(19) United States
(12) Patent Application Publication
(10) Pub. No.: US 2024/0267356 A1
(43) Pub. Date: Aug. 8, 2024

(54) SYSTEM AND METHOD FOR AUTOMATED STATIC IP CONFIGURATION

(71) Applicant: Akashdeep CHOPRA

(72) Inventor: Akashdeep CHOPRA

(21) Appl. No.: 18/041,573

(22) PCT Filed: Dec. 27, 2022
(86) PCT No.: PCT/US2022/054056

§ 371 Date: Feb. 14, 2023

(51) Int. Cl. H04L 61/5007; H04L 41/0806; H04L 61/5061

(52) U.S. Cl. CPC H04L 61/5007; H04L 41/0806; H04L 61/5061

(57) ABSTRACT

Provided are a method and system for automated static IP configuration. The method, which may be performed by at least one processor is for assigning static IP addresses to one or more pods to instantiate a Network Function (NF), the method comprising: requesting a plurality of static IP addresses; storing the plurality of static IP addresses in a central inventory; and assigning the plurality of static IP addresses to a payload, wherein the payload can be used to instantiate the NF upon deployment.

### FIELD

Systems and methods consistent with example embodiments of the present disclosure relate to handling of automated static IP configuration in telecommunication systems.

### BACKGROUND

A radio access network (RAN) is an important component in a telecommunications system, as it connects end-user devices (or user equipment) to other parts of the network. The RAN includes a combination of various network elements (NEs) that connect the end-user devices to a core network. Traditionally, hardware and/or software of a particular RAN is vendor specific.

Recently, the evolution of telco technologies enables many telco services to be realized virtually, in the form of software. For instance, RANs such as Open RAN (O-RAN) architectures, disaggregate one network component into multiple functional elements. By way of example, a baseband unit (BBU) or base station (i.e., eNB or gNB) is disaggregated into a number of functional elements including a distributed unit (DU) and a centralized unit (CU), wherein the CU can be further disaggregated into Centralized Unit-Control Plane (CU-CP) and Centralized Unit-User Plane (CU-UP). The disaggregation of network elements enables the telco services and the associated functions to be defined and provided in software-based form or virtual network services, such as Virtualized Network Functions (VNFs), Cloud-native Network Functions (CNFs) or Software Defined Networking (SDN), among others.

Automation in the O-RAN system may be achieved by utilizing a Service Management and Orchestration (SMO) framework. The SMO framework manages and orchestrates RAN elements. In particular, in the related art, the SMO may include a Network Function Orchestrator (NFO) that manages Virtual Machines (VM) based VNFs and container (i.e., instance) based VNFs.

In the related art, a Network Function (NF) of the O-RAN system may be deployed as microservices in cloud-based computing by utilizing Pods. In particular, each Pod may have an allocated IP address, and can include one or more containerized applications. The aforementioned SMO framework may be responsible for automation of instantiating and terminating such NFs in relation to the Pods.

In the related art, the SMO framework may instantiate the NF by using the NFO to generate an IP address, and generating a payload in order to deploy the NF in the one or more Pods. However, a problem may arise when the NF is terminated, since the pod's IP address is typically a dynamic IP address, retention of the pod's IP address may not be guaranteed, such that it may cause disruptions in connections with some of the related microservices (for instance, F1C and x2 connection with the appropriate microservices in the O-RAN architecture).

On the other hand, using a static IP address in the related art may inadvertently affect the NF's ability to be scaled. For instance, if the NF is initially instantiated using a single pod with a single static IP address, and the user would like to increase the number of pods for the NF (referred to as “scaling up”), the SMO may not have a method to allocate more static IP's to the already instantiated NF. Therefore, there is as need to be able to allocate IP addresses to Pods for a NF which can guarantee that the Pod's IP address is retained upon NF termination, while allowing scaling to be achieved.

### SUMMARY

Example embodiments of the present disclosure provide a method and system for assigning static IP addresses to a payload that is to be deployed to instantiate a NF (e.g., CU, CU-CP, CU-UP, DU). Specifically, the example embodiments may allocate a plurality of static IP addresses by using an orchestration framework to obtain a plurality of static IP addresses (for instance, from an IP address manager (IPAM)), store the obtained plurality of static IP addresses in a central inventory, and then allocate the static IP addresses to the payload.

Accordingly, example embodiments of the present disclosure may allow for automated assignment by the orchestration framework of a plurality of static IP addresses to the payload during instantiation of the NF, thereby eliminating possibility of subsequent connection issues when the NF is terminated (i.e., disruptions which may have previously been caused if the IP address of a pod for implementing the NF is not retained), and also allow for subsequent scaling of the NF since the payload may contain additional static IP addresses that the NF can utilize.

According to embodiments, a method may be performed by at least one processor for assigning static IP addresses to one or more pods to instantiate a Network Function (NF). The method may include: requesting a plurality of static IP addresses; storing the plurality of static IP addresses in a central inventory; and assigning the plurality of static IP addresses to a payload, wherein the payload can be used to instantiate the NF upon deployment.

Requesting the plurality of static IP addresses may further include receiving, from a manifest file, a first multinode value indicating the requested number of static IP addresses to be assigned to the payload; and requesting, from an IP address management (IPAM), the plurality of static IP addresses based on the first multinode value.

Assigning the plurality of static IP addresses to a payload may further include: receiving, from a manifest file, a second multinode value indicating the requested number of static IP addresses that are to be initially used upon instantiation of the NF; and assigning, to the payload, static IP addresses from the plurality of static IP addresses as static IP addresses that are to be initially used upon instantiation of the NF based on the second multinode value.

Assigning the plurality of static IP addresses to a payload may further include: assigning, to the payload, the remainder of the static IP addresses from the plurality of static IP addresses as static IP addresses which may be used after instantiation of the NF.

According to embodiments, the method may further include: deploying the payload to instantiate the NF; and based on deploying the payload, allocating to the one or more pods in the NF the static IP addresses which were assigned for use upon instantiation of the NF based on the second multinode value.

According to embodiments, the method may further include: deploying the payload to instantiate the NF; and based on deploying the payload, allocating to the one or more pods in the NF the static IP addresses which were assigned for use upon instantiation of the NF based on the second multinode value.

The instruction to scale up the NF may indicate the additional number of static IP addresses to be utilized.

According to embodiments, an apparatus for assigning static IP addresses to one or more pods to instantiate a Network Function (NF) may be provided. The apparatus may include at least one processor configured to execute computer-executable instructions to: request a plurality of static IP addresses; store the plurality of static IP addresses in a central inventory; and assign the plurality of static IP addresses to a payload, wherein the payload can be used to instantiate the NF upon deployment.

The at least one processor may further execute the computer-executable instructions to request the plurality of static IP addresses by: receiving, from a manifest file, a first multinode value indicating the requested number of static IP addresses to be assigned to the payload; and requesting, from an IP address management (IPAM), the plurality of static IP addresses based on the first multinode value.

The at least one processor may further be configured to execute the computer-executable instructions to assign the plurality of static IP addresses to a payload by: receiving, from a manifest file, a second multinode value indicating the requested number of static IP addresses that are to be initially used upon instantiation of the NF; and assigning, to the payload, static IP addresses from the plurality of static IP addresses as static IP addresses that are to be initially used upon instantiation of the NF based on the second multinode value.

The at least one processor may further be configured to execute the computer-executable instructions to assign the plurality of static IP addresses to a payload by: assigning, to the payload, the remainder of the static IP addresses from the plurality of static IP addresses as static IP addresses which may be used after instantiation of the NF.

The at least one processor may further be configured to execute the computer-executable instructions to: deploy the payload to instantiate the NF; and based on deploying the payload, allocate to the one or more pods in the NF the static IP addresses which were assigned for use upon instantiation of the NF based on the second multinode value.

The at least one processor may further be configured to execute the computer-executable instructions to: receive an instruction to scale up the NF; based on receiving the instruction to scale up the NF, allocate to the one or more pods in the NF the static IP addresses which were assigned for use after instantiation of the NF.

According to embodiments, a non-transitory computer-readable recording medium having recorded thereon instructions executable by at least one processor may be provided. The instructions may cause the at least one processor to perform a method comprising: requesting a plurality of static IP addresses; storing the plurality of static IP addresses in a central inventory; and assigning the plurality of static IP addresses to a payload, wherein the payload can be used to instantiate the NF upon deployment.

Requesting the plurality of static IP addresses may include: receiving, from a manifest file, a first multinode value indicating the requested number of static IP addresses to be assigned to the payload; and requesting, from an IP address management (IPAM), the plurality of static IP addresses based on the first multinode value.

Assigning the plurality of static IP addresses to a payload may include: receiving, from a manifest file, a second multinode value indicating the requested number of static IP addresses that are to be initially used upon instantiation of the NF; and assigning, to the payload, static IP addresses from the plurality of static IP addresses as static IP addresses that are to be initially used upon instantiation of the NF based on the second multinode value.

Assigning the plurality of static IP addresses to the payload may further include: assigning, to the payload, the remainder of the static IP addresses from the plurality of static IP addresses as static IP addresses which may be used after instantiation of the NF.

The method may further include: deploying the payload to instantiate the NF; and based on deploying the payload, allocating to the one or more pods in the NF the static IP addresses which were assigned for use upon instantiation of the NF based on the second multinode value.

The method may further include: receiving an instruction to scale up the NF; based on receiving the instruction to scale up the NF, allocating to the one or more pods in the NF the static IP addresses which were assigned for use after instantiation of the NF.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates a block diagram of a system for managing the network function (NF) deployment using a payload based on a orchestration framework according to one or more embodiments.

FIG. 2 illustrates a block diagram for an example method for assigning static IP addresses to the payload, according to one or more embodiments;

FIG. 3 illustrates an example manifest file used by the orchestration framework, according to one or more examples;

FIG. 4 illustrates a block diagram of an example configuration of the payload after the static IP addresses have been assigned, according to one or more examples

FIG. 5 illustrates a block diagram for an example method for deploying the payload and scaling up the NF, according to one or more embodiments;

FIG. 6 is a diagram of an example call flow for implementing the systems and methods described herein;

FIG. 7 is a diagram of an example environment in which systems and/or methods, described herein, may be implemented; and

FIG. 8 is a diagram of example components of a device according to an embodiment.

### DETAILED DESCRIPTION

The following detailed description of example embodiments refers to the accompanying drawings.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Example embodiments of the present disclosure are directed towards improving reliability and performance of a deployed network function (NF) that may be utilized in telecommunications architecture (such as O-RAN), as well as automation in deploying such NFs. In particular, example embodiments of the present disclosure provide a method and system for assigning static IP addresses to a payload that is to be deployed to instantiate a NF (e.g., CU, CU-CP, CU-UP, DU). Specifically, the example embodiments may allocate a plurality of static IP addresses by using an orchestration framework to obtain a plurality of static IP addresses (for instance, from an IP address manager (IPAM)), store the obtained plurality of static IP addresses in a central inventory, and then allocate the static IP addresses to the payload.

Accordingly, example embodiments of the present disclosure may allow for automated assignment by the orchestration framework of a plurality of static IP addresses to the payload during instantiation of the NF, thereby eliminating possibility of subsequent connection issues when the NF is terminated (i.e., disruptions which may have previously been caused if the IP address of a pod for implementing the NF is not retained), and also allow for subsequent scaling of the NF since the payload may contain additional static IP addresses that the NF can utilize.

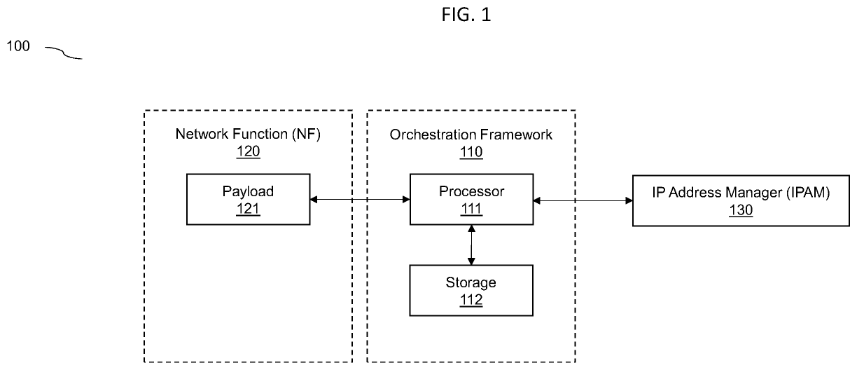

FIG. 1 illustrates a block diagram of a system 100 for assignment of static IP addresses by an orchestration framework 110 to a payload 121 which may be deployed for instantiation of a Network Function (NF) 120 according to an example embodiment.

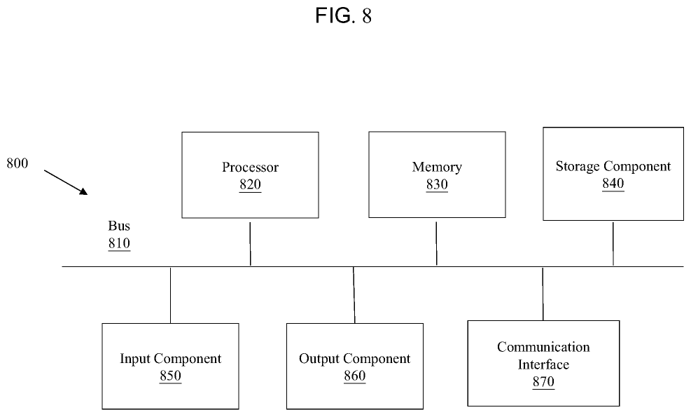

Referring to FIG. 1, orchestration framework 110 may include a processor 111 and storage 112. Processor 111 may be implemented by any appropriate configuration (e.g., implemented in hardware, firmware, or a combination of hardware and software), as discussed in detail with reference to FIG. 8 below. Storage 112 may include any suitable storage medium, such as server, web storage, memory device, and the like, which may store data and information associated with the orchestration framework. In one or more embodiments, storage 112 may include a central inventory of static IP addresses, and processor 111 may provide instructions to save static IP addresses in the central inventory of static IP addresses.

According to an example embodiment, processor 111 of the orchestration framework 110 may be communicatively coupled to the payload 121. In particular, the processor 111 may perform various operations on the payload 121 (e.g., generate, modify, delete, etc.). Furthermore, processor 111 may provide instructions to deploy the payload 121, which may thereby instantiate NF 120 according to the example embodiment.

In an example embodiment, when NF 120 is instantiated, it may be deployed by using one or more pods in cloud-based computing architecture for O-RAN. Nevertheless, it should be appreciated that the NF may be implemented in any appropriate architecture (e.g., using containerized functions, virtual machines, etc.). While the current example embodiment refers to pods, it is understood that one or more others are not limited thereto, and may for example use other units of duplication.

The static IP addresses may be obtained from a system or method external to the orchestration framework 110, such as being obtained from an IP Address Manager (IPAM) 130, as illustrated in FIG. 1 Processor 111 may provide instructions to request a plurality of static IP addresses from IPAM 130. It is contemplated that the static IP addresses may be obtained from any appropriate means, and it is not limited to only being obtained from IPAM 130.

It is contemplated that the configuration of system 100 may be arranged in a manner different from those described above, without departing from the scope of the present disclosure.

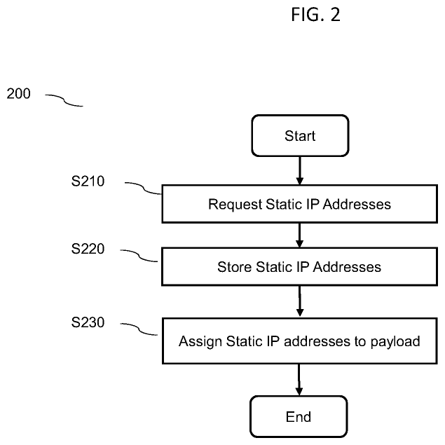

FIG. 2 illustrates an example block diagram of a method 200 for assigning static IP addresses to payload 121, according to one or more embodiments. Method 200 may be performed by processor 111 of the orchestration framework 110 in order to assign the static IP addresses to payload 121 prior to deployment of payload 121 to instantiate NF 120.

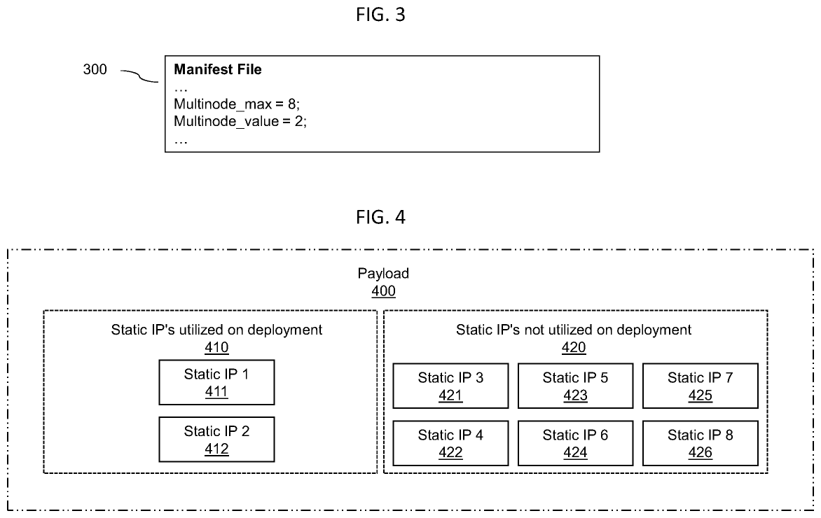

Referring to FIG. 2, at operation S210, a plurality of static IP addresses may be requested. For instance, this may be an instruction from processor 111 of the orchestration framework 110 to request a plurality of static IP addresses. It should be appreciated that the instruction for requesting the static IP addresses may be in any appropriate source or format. For example, the instruction may be obtained from a manifest file containing configuration values with regards to the total number of static IP addresses that should be obtained (e.g., FIG. 3 may exemplify an embodiment of utilizing such a manifest file). Further descriptions related to using a manifest file will be provided further below in relation to the description of FIG. 3.

According to an embodiment, operation S210 may be performed to request the plurality of static IP addresses from a system or process external to the orchestration framework 110, such as from IPAM 130.

Referring again to FIG. 2, at operation S220, the plurality of static IP addresses obtained in operation S210 may be saved in a central inventory. For instance, this may be an instruction from processor 111 of the orchestration framework 110 to save the obtained plurality of static IP addresses in storage 112. The central inventory may allow for the orchestration framework to refer to the static IP addresses allocated to NF 120.

Referring back to FIG. 2, at operation S230, the plurality of static IP addresses obtained in operation S210 and saved in S220 may be assigned or added to payload 121 which is to be deployed in order to instantiate NF 120. For instance, this may be an instruction from processor 111 of the orchestration framework 110 to add the obtained plurality of static IP addresses to the payload, and/or to generate the payload including the obtained plurality of static IP addresses.

According to an embodiment, operation S230 may include instructing the payload 121 that only some of the static IP addresses are to be used upon initial deployment of the payload 121 to instantiate NF 120. For example, the instruction may be obtained, by processor 111 of orchestration framework 110, from a manifest file containing configuration values with regards to the number of static IP addresses that should be used upon deployment (e.g., FIG. 3 may exemplify an embodiment of utilizing such a manifest file). The remainder of the static IP addresses may be assigned as static IP addresses which are to be used at a later time after deployment of the payload 121 to instantiate NF 120 (e.g., FIG. 4 may exemplify an embodiment of how the static IP addresses are allocated in the payload after assignment). Further descriptions related to allocation of the static IP addresses in the payload 121 will be provided further below in relation to the description of FIGS. 3 and 4.

According to the example embodiments as described above, after the static IP addresses are assigned to payload 121, orchestration framework 110 may instruct payload 121 to be deployed to instantiate NF 120, and the appropriate number of static IP addresses will be utilized to assign to the appropriate one or more pods. Accordingly, it may be appreciated that method 200 can be automatically performed by the processor 111 of orchestration framework 110 in order to automatically assign a plurality of static IP addresses to NF 120. It may also be appreciated that even if one or more of the pods or NF 120 is terminated, since static IP addresses are assigned to the one or more pods, the respective one or more pods or NF 120 may be instantiated at a later time without causing connection issues. As a result, method 200 in the example embodiment may improve the overall efficiency and reliability of a telecommunications system (such as the O-RAN architecture).

FIG. 3 illustrates an example of a manifest file which may be used (e.g., read a instructions) by processor 111 of orchestration framework 110 in order to allow the user (e.g., the system administrator) to configure how many static IP addresses should be allocated to NF 120, as well as how many static IP addresses should be utilized upon initial deployment of payload 121 to instantiate NF 120.

Referring to FIG. 3, the manifest file may contain a first multinode value “multinode_max”, which may indicate the total number of static IP addresses to be requested in relation to operation S210. In the illustrated example in FIG. 3, the first multinode value is “8”, which may indicate that 8 static IP addresses should be requested in relation to operation S210. In a similar manner, the manifest file may also contain a second multinode value “multinode_value”, which may indicate the number of static IP addresses that are only to be utilized upon initial deployment of payload 121 to instantiate NF 120, in relation to operation S230 above. In the illustrated example in FIG. 3, the second multinode value is “2”, which may indicate that 2 static IP addresses should be utilized upon initial deployment of payload 121 to instantiate NF 120, in relation to operation S230 above.

It should be appreciated that processor 111 of orchestration framework 110 may readily be able to determine the remaining number of static IP addresses which are to be assigned to payload 121, but are not to be used upon initial deployment of payload 121 to instantiate NF 120. For instance, in the above example illustrated in FIG. 3, the processor 111 of orchestration framework 110 may be able to determine, based on the first multinode value being “8” and the second multinode value being “2”, that the remaining number of static IP addresses which are to be assigned to payload 121, but are not to be used upon initial deployment of payload 121 to instantiate NF 120, should be 6 static IP addresses. It should also be appreciated that the illustrated example in FIG. 3 may only be an excerpt of the overall manifest file, and that the user may be able to specify other configurations in relation to assigning the static IP addresses without being limited to the above.

FIG. 4 illustrates an example block diagram of payload 400 after assigning the static IP addresses, which indicates how the static IP addresses may be separated into subsets based on whether the static IP addresses should be used upon initial deployment to instantiate the NF, according to an example embodiment. The structure of payload 400 may result from an appropriate instruction (such as the one above illustrated in FIG. 3) to assign the static IP addresses and/or generate the payload.

Referring to FIG. 4, payload 400 may contain a first subset 410 of static IP addresses which are to be utilized upon deployment, and a second subset 420 of static IP addresses which are not to be utilized upon deployment. In the illustrated example, static IP addresses 411 and 412 (a total of 2 static IP addresses) belong to the first subset of static IP addresses which are to be utilized upon deployment. Meanwhile, static IP addresses 421, 422, 423, 424, 425, and 426 (a total of 6 static IP addresses) belong to the second subset of static IP addresses which are not to be utilized upon deployment. It should be appreciated that any appropriate data structure used can be used for the subsets. For example, the IP addresses may be arranged in a sequential list, so that they can be used in a certain order.

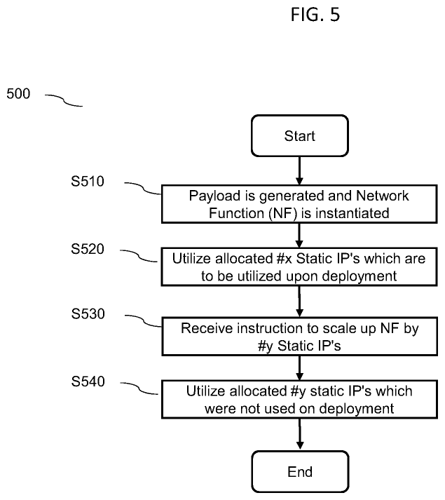

The second subset 420 of static IP addresses which are not to be utilized upon deployment may allow for the associated NF to increase its processing ability after deployment of the payload 400 and instantiation of the NF. In particular, the static IP addresses from second subset 420 may be utilized after deployment of payload 400, by assigning the static IP addresses from second subset 420 to additional pods (this operation may be referred to as “scaling up” hereinafter). Descriptions for an example regarding the operation of scaling up is described in the related description of FIG. 5 below.

FIG. 5 illustrates an example block diagram of a method 500 for the deployment of payload 121 and instantiation of NF 120, followed by a subsequent operation of scaling up NF 120, according to one or more embodiments. Method 500 may be performed by processor 111 of the orchestration framework 110, or other elements in system 100 as appropriate.

Referring to FIG. 5, at operation S510, payload 121 may be deployed, and NF 120 may be instantiated. Subsequently or concurrently, at operation S520, a number of static IP addresses (#x) which are to be utilized upon deployment of the payload 121/instantiation of NF 120 are assigned to the appropriate pods in the network.

At a later time after instantiation of NF 120 has occurred, at operation S530, processor 111 of the orchestration framework 110 may receive an instruction to scale up NF 120. In some embodiments, this instruction may indicate the number of static IP addresses (#y) which are to be assigned to the appropriate pods in the network. Nevertheless, it should be noted that the instruction may be in any appropriate form, and may include additional or less parameters as appropriate.

Referring back to FIG. 5, after receiving the instruction at operation S530, the processor 111 of the orchestration framework 110 may communicate with NF 120 at operation S540 to relay the instruction to utilize a number (for example, #y) of the static IP addresses which were not utilized upon deployment (for example, from second subset 420 with reference to FIG. 4 above) to assign to the appropriate one or more pods in the network.

It should be appreciated that in some embodiments, operations S530 and S540 can be performed independently of operations S510 and S520, and operations S530 and S540 can be repeated any number of times. For instance, after a first scaling up of NF 120, the user may opt to scale up NF 120 a second time, and so operations S530 and S540 can be repeated. It is also noted that the inverse of operations S530 and S540 could be performed to “scale down” NF 120, by un-assigning the appropriate one or more pods in the network.

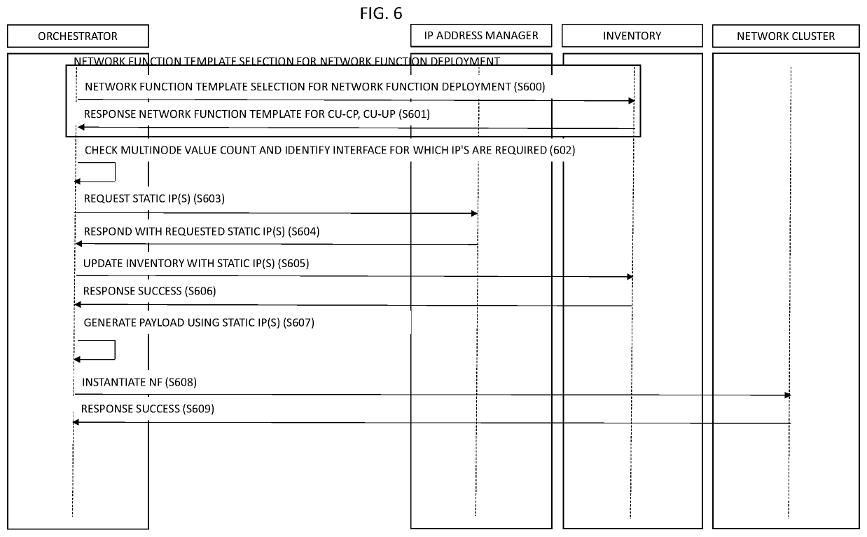

FIG. 6 illustrates an example call flow diagram for deployment and instantiation of an NF 120, according to embodiments. This may be performed by processor 111 of the orchestration framework 110, or other elements in system 100 as appropriate. IP Address Manager may correspond to IPAM 130, inventory may correspond to storage 112. The network cluster may correspond to the network where NF 120 is deployed.

At operations S600 and S601, network function template (NFT) selection for network function (NF) deployment is performed. At operation S600, the orchestrator may query the inventory to select the NFT. At operation S601, the inventory may respond to the orchestrator with response NFT for the NF (e.g., CU-CP, CU-UP).

At operation S602, the orchestrator may check the multinode value count (for example, the multinode value in manifest file 300 as illustrated in FIG. 3 as described above), in order to determine how many static IP(s) are required for the network function interface.

At operation S603, the orchestrator may request the number of static IP(s) determined from operation S602 from an IPAM. At operation S604, the IPAM may respond to the orchestrator with the requested static IP(s).

At operation S605, the orchestrator may update the inventory with the static IP(s) obtained in S605. At operation S606, the inventory may indicate to the orchestrator that the response/update of the inventory was successful.

At operation S607, the payload (for example, payload 121) may be generated by the orchestrator using the static IP(s) obtained in operation S604. At operation S608, the NF may be instantiated by deploying the payload to pods in the network (i.e., the network cluster). Finally, at operation S609, the network cluster may indicate to the orchestrator that the NF deployment/instantiation was successful.

Thus, according to the above example embodiments illustrated in FIGS. 3-6, the orchestration framework 110 can provide appropriate instructions to assign to payload 121 static IP addresses which are to be utilized upon instantiation of NF 120, and static IP addresses which can be utilized at a later time in order to scale up NF 120. As a result, the flexibility in automation of the orchestration framework for managing NFs is improved, since the resource usage of the NF can be adjusted without having to obtain new static IP addresses, since the static IP addresses are already pre-allocated for each NF.

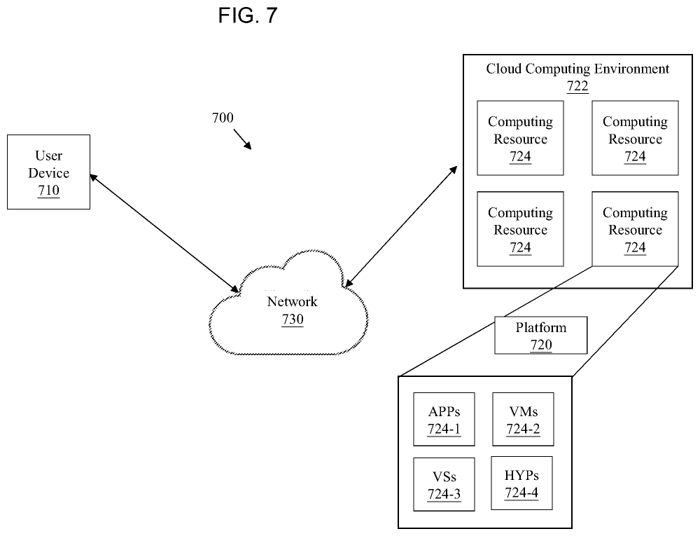

FIG. 7 is a diagram of an example environment 700 in which systems and/or methods, described herein, may be implemented. As shown in FIG. 7, environment 700 may include a user device 710, a platform 720, and a network 730. Devices of environment 700 may interconnect via wired connections, wireless connections, or a combination of wired and wireless connections. In embodiments, any of the functions and operations described with reference to FIGS. 1 through 6 above may be performed by any combination of elements illustrated in FIG. 7.

User device 710 includes one or more devices capable of receiving, generating, storing, processing, and/or providing information associated with platform 720. For example, user device 710 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 710 may receive information from and/or transmit information to platform 720.

Platform 720 includes one or more devices capable of receiving, generating, storing, processing, and/or providing information. In some implementations, platform 720 may include a cloud server or a group of cloud servers. In some implementations, platform 720 may be designed to be modular such that certain software components may be swapped in or out depending on a particular need. As such, platform 720 may be easily and/or quickly reconfigured for different uses.

In some implementations, as shown, platform 720 may be hosted in cloud computing environment 722. Notably, while implementations described herein describe platform 720 as being hosted in cloud computing environment 722, in some implementations, platform 720 may not be cloud-based (i.e., may be implemented outside of a cloud computing environment) or may be partially cloud-based.

Cloud computing environment 722 includes an environment that hosts platform 720. Cloud computing environment 722 may provide computation, software, data access, storage, etc., services that do not require end-user (e.g., user device 710) knowledge of a physical location and configuration of system(s) and/or device(s) that hosts platform 720. As shown, cloud computing environment 722 may include a group of computing resources 724 (referred to collectively as “computing resources 724” and individually as “computing resource 724”).

Computing resource 724 includes one or more personal computers, a cluster of computing devices, workstation computers, server devices, or other types of computation and/or communication devices. In some implementations, computing resource 724 may host platform 720. The cloud resources may include compute instances executing in computing resource 724, storage devices provided in computing resource 724, data transfer devices provided by computing resource 724, etc. In some implementations, computing resource 724 may communicate with other computing resources 724 via wired connections, wireless connections, or a combination of wired and wireless connections.

As further shown in FIG. 7, computing resource 724 includes a group of cloud resources, such as one or more applications (“APPs”) 724-1, one or more virtual machines (“VMs”) 724-2, virtualized storage (“VSs”) 724-3, one or more hypervisors (“HYPs”) 724-4, or the like.

Application 724-1 includes one or more software applications that may be provided to or accessed by user device 710. Application 724-1 may eliminate a need to install and execute the software applications on user device 710. For example, application 724-1 may include software associated with platform 720 and/or any other software capable of being provided via cloud computing environment 722. In some implementations, one application 724-1 may send/receive information to/from one or more other applications 724-1, via virtual machine 724-2.

Virtual machine 724-2 includes a software implementation of a machine (e.g., a computer) that executes programs like a physical machine. Virtual machine 724-2 may be either a system virtual machine or a process virtual machine, depending upon use and degree of correspondence to any real machine by virtual machine 724-2. A system virtual machine may provide a complete system platform that supports execution of a complete operating system (“OS”). A process virtual machine may execute a single program, and may support a single process. In some implementations, virtual machine 724-2 may execute on behalf of a user (e.g., user device 710), and may manage infrastructure of cloud computing environment 722, such as data management, synchronization, or long-duration data transfers.

Virtualized storage 724-3 includes one or more storage systems and/or one or more devices that use virtualization techniques within the storage systems or devices of computing resource 724. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 724-4 may provide hardware virtualization techniques that allow multiple operating systems (e.g., “guest operating systems”) to execute concurrently on a host computer, such as computing resource 724. Hypervisor 724-4 may present a virtual operating platform to the guest operating systems, and may manage the execution of the guest operating systems. Multiple instances of a variety of operating systems may share virtualized hardware resources.

Network 730 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 7 are provided as an example. In practice, there may be additional devices and/or networks, fewer devices and/or networks, different devices and/or networks, or differently arranged devices and/or networks than those shown in FIG. 7. Furthermore, two or more devices shown in FIG. 7 may be implemented within a single device, or a single device shown in FIG. 7 may be implemented as multiple, distributed devices. Additionally, or alternatively, a set of devices (e.g., one or more devices) of environment 700 may perform one or more functions described as being performed by another set of devices of environment 700.

FIG. 8 is a diagram of example components of a device 800. Device 800 may correspond to user device 710 and/or platform 720. As shown in FIG. 8, device 800 may include a bus 810, a processor 820, a memory 830, a storage component 840, an input component 850, an output component 860, and a communication interface 870.

Bus 810 includes a component that permits communication among the components of device 800. Processor 820 may be implemented in hardware, firmware, or a combination of hardware and software. Processor 820 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 820 includes one or more processors capable of being programmed to perform a function. Memory 830 includes a random access memory (RAM), a read only memory (ROM), and/or another type of dynamic or static storage device (e.g., a flash memory, a magnetic memory, and/or an optical memory) that stores information and/or instructions for use by processor 820.

Storage component 840 stores information and/or software related to the operation and use of device 800. For example, storage component 840 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 850 includes a component that permits device 800 to receive information, such as via user input (e.g., a touch screen display, a keyboard, a keypad, a mouse, a button, a switch, and/or a microphone). Additionally, or alternatively, input component 850 may include a sensor for sensing information (e.g., a global positioning system (GPS) component, an accelerometer, a gyroscope, and/or an actuator). Output component 860 includes a component that provides output information from device 800 (e.g., a display, a speaker, and/or one or more light-emitting diodes (LEDs)).

Communication interface 870 includes a transceiver-like component (e.g., a transceiver and/or a separate receiver and transmitter) that enables device 800 to communicate with other devices, such as via a wired connection, a wireless connection, or a combination of wired and wireless connections. Communication interface 870 may permit device 800 to receive information from another device and/or provide information to another device. For example, communication interface 870 may include an Ethernet interface, an optical interface, a coaxial interface, an infrared interface, a radio frequency (RF) interface, a universal serial bus (USB) interface, a Wi-Fi interface, a cellular network interface, or the like.

Device 800 may perform one or more processes described herein. Device 800 may perform these processes in response to processor 820 executing software instructions stored by a non-transitory computer-readable medium, such as memory 830 and/or storage component 840. A computer-readable medium is defined herein as a non-transitory memory device. A memory device includes memory space within a single physical storage device or memory space spread across multiple physical storage devices.

Software instructions may be read into memory 830 and/or storage component 840 from another computer-readable medium or from another device via communication interface 870. When executed, software instructions stored in memory 830 and/or storage component 840 may cause processor 820 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 8 are provided as an example. In practice, device 800 may include additional components, fewer components, different components, or differently arranged components than those shown in FIG. 8. Additionally, or alternatively, a set of components (e.g., one or more components) of device 800 may perform one or more functions described as being performed by another set of components of device 800.

In embodiments, any one of the operations or processes of FIGS. 1 through 6 may be implemented by or using any one of the elements illustrated in FIGS. 7 and 8. It is understood that other embodiments are not limited thereto, and may be implemented in a variety of different architectures (e.g., bare metal architecture, any cloud-based architecture or deployment architecture such as Kubernetes, Docker, OpenStack, etc.).

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

### Various Aspects of Embodiments

Various further respective aspects and features of embodiments of the present disclosure may be defined by the following items:
Item [1]: A method, performed by at least one processor, for assigning static IP addresses to one or more pods to instantiate a Network Function (NF), the method comprising: requesting a plurality of static IP addresses; storing the plurality of static IP addresses in a central inventory; and assigning the plurality of static IP addresses to a payload, wherein the payload can be used to instantiate the NF upon deployment.
Item [2]: The method according to item [1], wherein requesting the plurality of static IP addresses further comprises: receiving, from a manifest file, a first multinode value indicating the requested number of static IP addresses to be assigned to the payload; and requesting, from an IP address management (IPAM), the plurality of static IP addresses based on the first multinode value.
Item [3]: The method according to any one of items [1]-[2], wherein assigning the plurality of static IP addresses to a payload further comprises: receiving, from a manifest file, a second multinode value indicating the requested number of static IP addresses that are to be initially used upon instantiation of the NF; and assigning, to the payload, static IP addresses from the plurality of static IP addresses as static IP addresses that are to be initially used upon instantiation of the NF based on the second multinode value.
Item [4]: The method according to item [3], wherein assigning the plurality of static IP addresses to a payload further comprises: assigning, to the payload, the remainder of the static IP addresses from the plurality of static IP addresses as static IP addresses which may be used after instantiation of the NF.
Item [5]: The method according to item [4], further including: deploying the payload to instantiate the NF; and based on deploying the payload, allocating to the one or more pods in the NF the static IP addresses which were assigned for use upon instantiation of the NF based on the second multinode value.
Item [6]: The method according to item [5], further including: deploying the payload to instantiate the NF; and based on deploying the payload, allocating to the one or more pods in the NF the static IP addresses which were assigned for use upon instantiation of the NF based on the second multinode value.
Item [7]: The method according to item [1], wherein the instruction to scale up the NF may indicate the additional number of static IP addresses to be utilized.
Item [8]: An apparatus for assigning static IP addresses to one or more pods to instantiate a Network Function (NF), the apparatus comprising at least one processor configured to execute computer-executable instructions to: request a plurality of static IP addresses; store the plurality of static IP addresses in a central inventory; and assign the plurality of static IP addresses to a payload, wherein the payload can be used to instantiate the NF upon deployment.
Item [9]: The apparatus according to item [8], wherein the at least one processor is further configured to execute the computer-executable instructions to request the plurality of static IP addresses by: receiving, from a manifest file, a first multinode value indicating the requested number of static IP addresses to be assigned to the payload; and requesting, from an IP address management (IPAM), the plurality of static IP addresses based on the first multinode value.
Item [10]: The apparatus according to any one of items [8]-[9], wherein the at least one processor is further configured to execute the computer-executable instructions to assign the plurality of static IP addresses to a payload by: receiving, from a manifest file, a second multinode value indicating the requested number of static IP addresses that are to be initially used upon instantiation of the NF; and assigning, to the payload, static IP addresses from the plurality of static IP addresses as static IP addresses that are to be initially used upon instantiation of the NF based on the second multinode value.
Item [11]: The apparatus according to item [10], wherein the at least one processor is further configured to execute the computer-executable instructions to assign the plurality of static IP addresses to a payload by: assigning, to the payload, the remainder of the static IP addresses from the plurality of static IP addresses as static IP addresses which may be used after instantiation of the NF.
Item [12]: The apparatus according to item [11], wherein the at least one processor is further configured to execute the computer-executable instructions to: deploy the payload to instantiate the NF; and based on deploying the payload, allocate to the one or more pods in the NF the static IP addresses which were assigned for use upon instantiation of the NF based on the second multinode value.
Item [13]: The apparatus according to item [12], wherein the at least one processor is further configured to execute the computer-executable instructions to: receive an instruction to scale up the NF; based on receiving the instruction to scale up the NF, allocate to the one or more pods in the NF the static IP addresses which were assigned for use after instantiation of the NF.
Item [14]: The apparatus according to item [13], wherein the instruction to scale up the NF may indicate the additional number of static IP addresses to be utilized.
Item [15] A non-transitory computer-readable recording medium having recorded thereon instructions executable by at least one processor to cause the at least one processor to perform a method comprising: requesting a plurality of static IP addresses; storing the plurality of static IP addresses in a central inventory; and assigning the plurality of static IP addresses to a payload, wherein the payload can be used to instantiate the NF upon deployment.
Item [16] The non-transitory computer readable recording medium according to Item [15], wherein the requesting the plurality of static IP addresses comprises: receiving, from a manifest file, a first multinode value indicating the requested number of static IP addresses to be assigned to the payload; and requesting, from an IP address management (IPAM), the plurality of static IP addresses based on the first multinode value.
Item [17] The non-transitory computer readable recording medium according to any one of Items [15]-[16], wherein the assigning the plurality of static IP addresses to a payload comprises: receiving, from a manifest file, a second multinode value indicating the requested number of static IP addresses that are to be initially used upon instantiation of the NF; and assigning, to the payload, static IP addresses from the plurality of static IP addresses as static IP addresses that are to be initially used upon instantiation of the NF based on the second multinode value.
Item [18] The non-transitory computer readable recording medium according to Item [17], wherein the assigning the plurality of static IP addresses to the payload further comprises: assigning, to the payload, the remainder of the static IP addresses from the plurality of static IP addresses as static IP addresses which may be used after instantiation of the NF.
Item [19] The non-transitory computer readable recording medium according to Item [18], The non-transitory computer readable recording medium as claimed in claim 18, wherein the method further comprises: deploying the payload to instantiate the NF; and based on deploying the payload, allocating to the one or more pods in the NF the static IP addresses which were assigned for use upon instantiation of the NF based on the second multinode value.
Item [20] The non-transitory computer readable recording medium according to Item [19], wherein the method further comprises: receiving an instruction to scale up the NF; based on receiving the instruction to scale up the NF, allocating to the one or more pods in the NF the static IP addresses which were assigned for use after instantiation of the NF.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A method, performed by at least one processor, for assigning static IP addresses to one or more pods to instantiate a Network Function (NF), the method comprising:
requesting a plurality of static IP addresses;
storing the plurality of static IP addresses in a central inventory; and
assigning the plurality of static IP addresses to a payload, wherein the payload can be used to instantiate the NF upon deployment.

2. The method as claimed in claim 1, wherein the requesting the plurality of static IP addresses comprises:
receiving, from a manifest file, a first multinode value indicating the requested number of static IP addresses to be assigned to the payload; and
requesting, from an IP address management (IPAM), the plurality of static IP addresses based on the first multinode value.

3. The method as claimed in claim 1, wherein the assigning the plurality of static IP addresses to a payload comprises:
receiving, from a manifest file, a second multinode value indicating the requested number of static IP addresses that are to be initially used upon instantiation of the NF; and
assigning, to the payload, static IP addresses from the plurality of static IP addresses as static IP addresses that are to be initially used upon instantiation of the NF based on the second multinode value.

4. The method as claimed in claim 3, wherein the assigning the plurality of static IP addresses to the payload further comprises:
assigning, to the payload, the remainder of the static IP addresses from the plurality of static IP addresses as static IP addresses which may be used after instantiation of the NF.

5. The method as claimed in claim 4, further comprising:
deploying the payload to instantiate the NF; and
based on deploying the payload, allocating to the one or more pods in the NF the static IP addresses which were assigned for use upon instantiation of the NF based on the second multinode value.

6. The method as claimed in claim 5, further comprising:
receiving an instruction to scale up the NF;
based on receiving the instruction to scale up the NF, allocating to the one or more pods in the NF the static IP addresses which were assigned for use after instantiation of the NF.

7. The method as claimed in claim 6, wherein the instruction to scale up the NF may indicate the additional number of static IP addresses to be utilized.

8. An apparatus for assigning static IP addresses to one or more pods to instantiate a Network Function (NF), the apparatus comprising at least one processor configured to execute computer-executable instructions to:
request a plurality of static IP addresses;
store the plurality of static IP addresses in a central inventory; and
assign the plurality of static IP addresses to a payload, wherein the payload can be used to instantiate the NF upon deployment.

9. The apparatus as claimed in claim 8, wherein the at least one processor is further configured to execute the computer-executable instructions to request the plurality of static IP addresses by:
receiving, from a manifest file, a first multinode value indicating the requested number of static IP addresses to be assigned to the payload; and
requesting, from an IP address management (IPAM), the plurality of static IP addresses based on the first multinode value.

10. The apparatus as claimed in claim 8, wherein the at least one processor is further configured to execute the computer-executable instructions to assign the plurality of static IP addresses to a payload by:
receiving, from a manifest file, a second multinode value indicating the requested number of static IP addresses that are to be initially used upon instantiation of the NF; and
assigning, to the payload, static IP addresses from the plurality of static IP addresses as static IP addresses that are to be initially used upon instantiation of the NF based on the second multinode value.

11. The apparatus as claimed in claim 10, wherein the at least one processor is further configured to execute the computer-executable instructions to assign the plurality of static IP addresses to a payload by:
assigning, to the payload, the remainder of the static IP addresses from the plurality of static IP addresses as static IP addresses which may be used after instantiation of the NF.

12. The apparatus as claimed in claim 11, wherein the at least one processor is further configured to execute the computer-executable instructions to:
deploy the payload to instantiate the NF; and
based on deploying the payload, allocate to the one or more pods in the NF the static IP addresses which were assigned for use upon instantiation of the NF based on the second multinode value.

13. The apparatus as claimed in claim 12, wherein the at least one processor is further configured to execute the computer-executable instructions to:
receive an instruction to scale up the NF;
based on receiving the instruction to scale up the NF, allocate to the one or more pods in the NF the static IP addresses which were assigned for use after instantiation of the NF.

14. The apparatus as claimed in claim 13, wherein the instruction to scale up the NF may indicate the additional number of static IP addresses to be utilized.

15. A non-transitory computer-readable recording medium having recorded thereon instructions executable by at least one processor to cause the at least one processor to perform a method comprising:
requesting a plurality of static IP addresses;
storing the plurality of static IP addresses in a central inventory; and
assigning the plurality of static IP addresses to a payload, wherein the payload can be used to instantiate the NF upon deployment.

16. The non-transitory computer readable recording medium as claimed in claim 15, wherein the requesting the plurality of static IP addresses comprises:
receiving, from a manifest file, a first multinode value indicating the requested number of static IP addresses to be assigned to the payload; and
requesting, from an IP address management (IPAM), the plurality of static IP addresses based on the first multinode value.

17. The non-transitory computer readable recording medium as claimed in claim 15, wherein the assigning the plurality of static IP addresses to a payload comprises:
receiving, from a manifest file, a second multinode value indicating the requested number of static IP addresses that are to be initially used upon instantiation of the NF; and
assigning, to the payload, static IP addresses from the plurality of static IP addresses as static IP addresses that are to be initially used upon instantiation of the NF based on the second multinode value.

18. The non-transitory computer readable recording medium as claimed in claim 17, wherein the assigning the plurality of static IP addresses to the payload further comprises:
assigning, to the payload, the remainder of the static IP addresses from the plurality of static IP addresses as static IP addresses which may be used after instantiation of the NF.

19. The non-transitory computer readable recording medium as claimed in claim 18, wherein the method further comprises:
deploying the payload to instantiate the NF; and
based on deploying the payload, allocating to the one or more pods in the NF the static IP addresses which were assigned for use upon instantiation of the NF based on the second multinode value.

20. The non-transitory computer readable recording medium as claimed in claim 19, wherein the method further comprises:
receiving an instruction to scale up the NF;
based on receiving the instruction to scale up the NF, allocating to the one or more pods in the NF the static IP addresses which were assigned for use after instantiation of the NF.
